(19) United States
(12) Patent Application Publication
(10) Pub. No.: US 2022/0340797 A1
(43) Pub. Date: Oct. 27, 2022

(54) STRUCTURE

(71) Applicant: DENSO CORPORATION, Kariya-city (JP)

(72) Inventor: Masami SAITO, Kariya-city (JP)

(21) Appl. No.: 17/859,448

(22) Filed: Jul. 7, 2022

Related U.S. Application Data
(63) Continuation of application No. PCT/JP2020/042952, filed on Nov. 18, 2020.

(30) Foreign Application Priority Data
Jan. 8, 2020 (JP) 2020-001210

(51) Int. Cl. C09J 183/04; C09J 163/00

(52) U.S. Cl. CPC C09J 183/04; C09J 163/00

(57) ABSTRACT

A structure includes an aluminum base and an adhesive layer that is made of an adhesive resin adhering to a surface of the aluminum base. The adhesive layer includes a hard layer that abuts against an adhesive interface where the hard layer is adhered to the aluminum base, and a body layer that abuts against the hard layer. The hard layer is harder than the body layer.

### CROSS-REFERENCE TO RELATED APPLICATION

The present application is a continuation application of International Application No. PCT/JP2020/042952, filed on Nov. 18, 2020, which claims priority to Japanese Patent Application No. 2020-001210, filed on Jan. 8, 2020. The contents of these applications are incorporated herein by reference in their entirety.

### BACKGROUND

### Technical Field

The present disclosure relates to a structure.

### Background Art

Hitherto, structures each including an aluminum base and an adhesive layer that is made of an adhesive resin such as an epoxy resin adhering to a surface of the aluminum base have been well known.

In addition, as disclosed in Patent Literature 1, structures in each of which a primer is applied between the aluminum base and the adhesive layer that is made of the adhesive resin also have been known.

### SUMMARY

In the present disclosure, provided is a structure as the following.

The structure includes an aluminum base and an adhesive layer. The adhesive layer is made of an adhesive resin, the adhesive resin being an epoxy resin or a silicone resin. The adhesive layer includes a hard layer that abuts against an adhesive interface where the hard layer is adhered to the aluminum base, and a body layer that abuts against the hard layer, the hard layer being harder than the body layer.

### BRIEF DESCRIPTION OF THE DRAWINGS

The above-described object, other objects, features, and advantages of the present disclosure become more apparent in light of the following detailed description with reference to the following accompanying drawings.

FIG. 1 is a schematic view of a structure according to a first embodiment.

FIG. 2A and FIG. 2B are explanatory views of an estimated mechanism that increases adhesion strength, in which FIG. 2A is a schematic view illustrating a state of an adhesive resin in the structure according to the first embodiment, and in which FIG. 2B is a schematic view illustrating a state of the adhesive resin in a structure according to a comparative example.

FIG. 3 is a schematic graph showing a relationship between adsorption force or elastic moduli and a distance from an adhesive interface in a cross-section of an adhesive layer.

FIG. 4 is a schematic view of a structure according to a second embodiment.

FIG. 5 is a depiction of an adsorption-force image of a cross-section of an adhesive layer of a sample 1, the adsorption-force image being generated through surface observation using a scanning probe microscope in Experimental Example 1.

FIG. 6 is a depiction of an adsorption-force image of a cross-section of an adhesive layer of a sample 1C, the adsorption-force image being generated through the surface observation using the scanning probe microscope in Experimental Example 1.

FIG. 7 is a depiction of an elastic-modulus image of the cross-section of the adhesive layer of the sample 1, the elastic-modulus image being generated through the surface observation using the scanning probe microscope in Experimental Example 1.

FIG. 8 is a depiction of an elastic-modulus image of the cross-section of the adhesive layer of the sample 1C, the elastic-modulus image being generated through the surface observation using the scanning probe microscope in Experimental Example 1.

FIG. 9 is a graph showing relationships between the adsorption force and distances from adhesive interfaces in the cross-sections of the adhesive layers of the sample 1 and the sample 1C, the relationships being obtained in Experimental Example 2.

FIG. 10 is a graph showing relationships between the adsorption force and distances from adhesive interfaces in cross-sections of adhesive layers of a sample 2 and a sample 2C, the relationships being obtained in Experimental Example 2.

FIG. 11 is a graph showing relationships between the elastic moduli and the distances from the adhesive interfaces in the cross-sections of the adhesive layers of the sample 1 and the sample 1C, the relationships being obtained in Experimental Example 2.

FIG. 12 is a graph showing relationships between the elastic moduli and the distances from the adhesive interfaces in the cross-sections of the adhesive layers of the sample 2 and the sample 2C, the relationships being obtained in Experimental Example 2.

FIG. 13 is a bar graph showing tensile shear strength of structures of the sample 1 and the sample 1C under each condition, the tensile shear strength being obtained in Experimental Example 3.

### DETAILED DESCRIPTION OF THE PREFERRED EMBODIMENTS

[PTL 1] JP 2000-239644 A

In each of the related-art well-known structures, a vicinity of an adhesive interface between the aluminum base and the adhesive layer is weak. Thus, in a case where the structures are exposed to a solvent for a long time period or to thermal shock, peeling occurs at the adhesive interface between the aluminum base and the adhesive layer.

The present disclosure has been made to achieve an object to provide a structure that is capable of exhibiting high adhesion strength even in a case of being exposed to a solvent for a long time period or to thermal shock.

According to an aspect of the present disclosure, there is provided a structure including:

an aluminum base; and

an adhesive layer configured to:
be made of an adhesive resin adhering to a surface of the aluminum base, the adhesive resin being an epoxy resin or a silicone resin, and
include:
   a hard layer that abuts against an adhesive interface where the hard layer is adhered to the aluminum base, and
   a body layer that abuts against the hard layer,
   the hard layer being harder than the body layer.

The above-described structure is capable of exhibiting high adhesion strength even in the case of being exposed to a solvent for a long time period or to thermal shock.

Note that, the parenthesized reference symbols used in the claims represent correspondences to specific means described hereinbelow in “Description of Embodiments,” and hence do not limit the technical scope of the present disclosure.

Structures according to embodiments each include an aluminum base, and an adhesive layer that is made of an adhesive resin adhering to a surface of the aluminum base. The adhesive layer includes a hard layer that abuts against an adhesive interface between the hard layer and the aluminum base, and a body layer that abuts against the hard layer. The hard layer is harder than the body layer.

The structures according to the embodiments are each capable of causing fracture to occur mainly in the body layer even in a case of being exposed to a solvent for a long time period or to thermal shock. In other words, main fracture in each of the structures according to the embodiments is not interface fracture but base-material fracture in the body layer. This is probably because, even when the adhesive layer is made of the common adhesive resin, in contrast to the body layer in which resin physical properties of the adhesive resin do not vary, resin physical properties of the adhesive resin in the hard layer which has been immobilized to the adhesive interface vary so that the hard layer is harder than the body layer, which leads to an increase in strength near the adhesive interface.

Thus, the structures according to the embodiments are capable of exhibiting high adhesion strength even in a case of being exposed to a solvent for a long time period or to thermal shock. Hereinbelow, detailed description thereof is given.

### First Embodiment

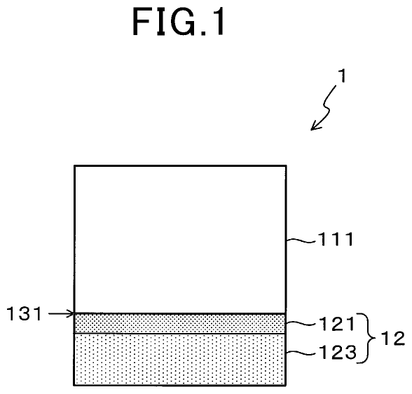

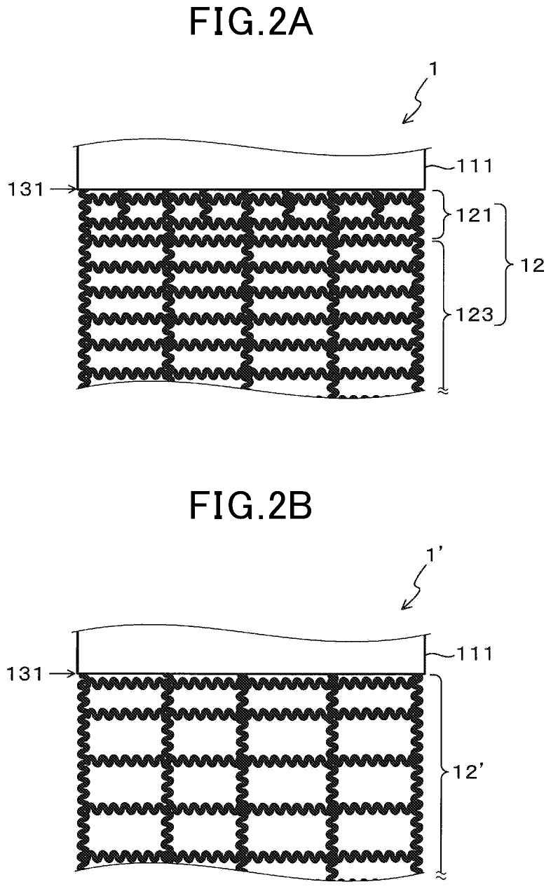

A structure according to a first embodiment is described with reference to FIG. 1 and FIG. 2. As exemplified in FIG. 1, a structure 1 according to the first embodiment includes an aluminum base 111 and an adhesive layer 12.

Examples of the aluminum of the aluminum base 111 include not only pure aluminum but also aluminum alloys. As specific examples of the aluminum base 111, there may be given bases of aluminum or aluminum-alloy members in various shapes. As examples of the aluminum alloys, there may be given 1000-series Al alloys, 2000-series Al alloys, 3000-series Al alloys, 4000-series Al alloys, 5000-series Al alloys, 6000-series Al alloys, and 7000-series Al alloys, and aluminum die-cast alloys such as ADC12.

Among surfaces of the aluminum base 111, at least an adhesive surface to which the adhesive layer 12 adheres may be modified. Specifically, an entirety or a part of an oxide-film layer (not shown) may be removed from the adhesive surface. In addition, a modified layer (not shown) that is made of silicate glass or the like may be formed on a surface of the adhesive surface from which the entirety or the part of the oxide-film layer has been removed. With this configuration, a covalent bond is easily formed between the modified layer and an adhesive resin, and high adhesion strength is easily exhibited synergistically with an advantage of improving strength near an adhesive interface 131. As examples of the silicate glass, there may be given aluminosilicate glass that is silicate glass containing a solid-solution of Al elements.

The adhesive layer 12 is made of the adhesive resin adhering to the surface of the aluminum base 111. Specifically, the adhesive layer 12 may be formed partially on the surface of the aluminum base 111, or may be formed all over the surface of the aluminum base 111.

Epoxy resin and silicone resin are used as the adhesive resin. Epoxy resin and silicone resin can form a covalent bond by a chemical reaction with an OH group that may be present on the surface of the aluminum base 111. Thus, the strength near the adhesive interface 131 is easily increased. For example, if the aluminum base 111 includes the modified layer that is made of silicate glass on its surface as described above, the epoxy resin can form the covalent bond by a chemical reaction of the OH group on a surface of the modified layer and an epoxy group. Meanwhile, the silicone resin can form the covalent bond by dehydration-condensation reaction with the OH group on the surface of the modified layer. Note that, as appropriate, the adhesive resin may contain one or more types of various additives to be added to general resin-based adhesives.

The adhesive layer 12 includes a hard layer 121 and a body layer 123. The hard layer 121 abuts against the adhesive interface 131 between the hard layer 121 and the aluminum base 111. The body layer 123 abuts against the hard layer 121. Since both the hard layer 121 and the body layer 123 are parts of the adhesive layer 12, basically, the hard layer 121 and the body layer 123 are integrally made of an adhesive resin of the same type as that of the adhesive resin forming the adhesive layer 12. Note that, a state of a polymer constituting the adhesive resin in the hard layer 121 and a state of the same in the body layer 123 are different from each other. Thus, the hard layer 121 and the body layer 123 are different from each other in hardness. Specifically, the hard layer 121 is harder than the body layer 123.

An estimated mechanism that enables a structure having such a configuration to exhibit the high adhesion strength is described. As exemplified in FIG. 2B, in a structure 1′ according to a comparative example, an adhesive layer 12′ does not include the hard layer 121 and the body layer 123, and an entirety of the adhesive layer 12′ has uniform hardness. In such a configuration, a crosslink density of an adhesive resin forming the adhesive layer 12′ is substantially uniform in a thickness direction of the adhesive layer 12′. Thus, strength near the adhesive interface 131 does not increase. Therefore, in the related-art structure 1′, peeling is liable to occur at the adhesive interface 131. In contrast, in the structure 1 according to this embodiment, the adhesive layer 12 includes the hard layer 121 and the body layer 123, and the hard layer 121 is harder than the body layer 123. In such a configuration, a crosslink density of the adhesive resin forming the hard layer 121 is higher than a crosslink density of the adhesive resin forming the body layer 123. Thus, the strength near the adhesive interface 131 is increased by the higher crosslink density. Note that, in FIG. 2, intersections between matrices illustrated in the adhesive layers 12 and 12′ correspond to crosslink points. With this, in the structure 1, the body layer 123 having relatively low strength fractures first (base-material fracture), and hence interface fracture at the adhesive interface 131 is unlikely to occur. Thus, even in the case of being exposed to a solvent for a long time period or to thermal shock, the structure 1 can exhibit the high adhesion strength.

The hard layer 121 may be configured to be bonded to the surface of the aluminum base 111 by the covalent bond. With this configuration, a solvent is less likely to enter the adhesive interface 131 than in a configuration in which the hard layer 121 is bonded to the surface of the aluminum base 111 by an anchoring effect or hydrogen-bonded. Thus, with this configuration, degradation in strength at the adhesive interface 131 is prevented, and hence an advantage of increasing the strength at the adhesive interface 131 can be reliably provided. In addition, reliability of long-term adhesion of the adhesive interface 131 is also increased. Note that, the hydrogen bond is cleaved by attack of solvent entering at the adhesive interface 131, and the cleaved parts act as new reaction points causing a chain reaction. Thus, when the hard layer 121 is hydrogen-bonded, the adhesive interface 131 is more likely to be deteriorated by solvent such as an organic solvent than in a case where the hard layer 121 is covalently bonded.

Note that, since the hardness of the adhesive layer 12 is related to the crosslink density of the adhesive resin as described above, directly, it can be determined that the hard layer 121 is harder than the body layer 123 also when the crosslink density of the hard layer 121 is higher than the crosslink density of the body layer 123 as a result of measuring relationships between the crosslink densities and a distance from the adhesive interface 131 to an inner side of the adhesive layer 12. However, it is difficult to measure distributions of the crosslink densities of the adhesive resin in the adhesive layer 12. In view of such circumstances, an inventor of this application has found by trial and error that the above-described functions and advantages can be provided, specifically, it can be determined that the hard layer 121 is harder than the body layer 123 when adsorption force of the hard layer 121 is larger than adsorption force of the body layer 123 and/or when an elastic modulus of the hard layer 121 is higher than an elastic modulus of the body layer 123 under a state in which adsorption force or an elastic modulus of the adhesive resin is selected as a resin physical property.

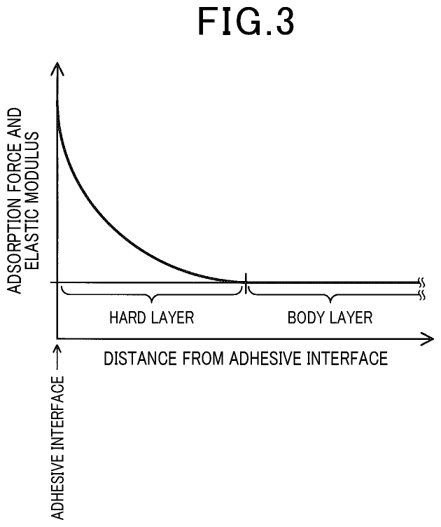

Specifically, as exemplified in FIG. 3, the structure 1 may have a configuration in which the adsorption force of the hard layer 121 is larger than the adsorption force of the body layer 123, the adsorption force being measured by using a scanning probe microscope in a cross-section of the adhesive layer 12, the cross-section being perpendicular to the adhesive interface 131. In addition, the structure 1 may have a configuration in which the elastic modulus of the hard layer 121 is higher than the elastic modulus of the body layer 123, the elastic moduli being measured by using the scanning probe microscope in the cross-section of the adhesive layer 12, the cross-section being perpendicular to the adhesive interface 131. With these configurations, the above-described functions and advantages can be reliably provided.

The adsorption force and the elastic moduli can be measured as follows. A measurement sample having the cross-section of the adhesive layer 12, the cross-section being perpendicular to the adhesive interface 131, is collected from the structure 1 being a measurement target. As the scanning probe microscope, a scanning probe microscope “SPM-9500” manufactured by Shimadzu Corporation. may be used. Note that, if this model has been discontinued and unavailable, successor models may be used. A Si₃N₄ AFM cantilever (“SN-AF01” (spring constant of 0.08 N/m) manufactured by Hitachi High-Tech Science Corporation.) is used as a probe. A measurement mode of the scanning probe microscope is set to a contact mode, and an operating mode of the same is set to a force curve mode. At a time of the measurement, a frequency is set to 1 Hz, and a contact voltage is set to 0.5 V. A force curve at each position on the adhesive layer 12 is measured by using the scanning probe microscope while gradually increasing the distance from the adhesive interface 131 exposed on the cross-section of the adhesive layer 12 along a thickness direction of the adhesive layer 12 in the measurement sample. In other words, a force curve at each of the positions in the cross-section of the adhesive layer 12 is measured while varying, in the adhesive layer 12, the distance from the adhesive interface 131 to the inner side of the adhesive layer 12. Then, an elastic modulus and adsorption force at each of the positions in the cross-section of the adhesive layer 12 are calculated from the force curve at each of the positions in the cross-section of the adhesive layer 12. Note that, in the measurement using the scanning probe microscope, when a cantilever is brought close to a surface of the measurement sample to come into contact with the measurement sample, the cantilever is deflected to a repulsive side. Then, the cantilever starts to be moved away from the measurement sample. At this time, although the deflection of the cantilever decreases, the cantilever is oppositely deflected to an attractive side by adsorption force that is generated between the surface of the measurement sample and the cantilever. After that, the cantilever completely separates from the surface of the measurement sample. The elastic moduli can be calculated from quantities of deflections at force-curve parts corresponding to parts at which the cantilever is deflected to the repulsive side. The adsorption force can be calculated from quantities of deflections at the force-curve parts corresponding to parts at which the cantilever separates from the measurement sample after being deflected to the attractive side. With this, as exemplified in FIG. 3, a graph showing a relationship between the adsorption force and the distance from the adhesive interface 131 in the cross-section of the adhesive layer 12, and a graph showing a relationship between the elastic moduli and the distance from the adhesive interface 131 in the cross-section of the adhesive layer 12 can be provided. In these relationship graphs, a region in which variation in adsorption force or elastic modulus in accordance with the distance from the adhesive interface 131 can be scarcely found corresponds to the body layer 123, and a region in which the adsorption force or the elastic modulus is higher than that of the body layer 123 and in which the variation in adsorption force or elastic modulus in accordance with the distance from the adhesive interface 131 can be found corresponds to the hard layer 121. In this way, the hard layer 121 of the adhesive layer 12 can be grasped as a region in which the variation in adsorption force or elastic modulus is larger in the adhesive resin immobilized to the adhesive interface 131 than in the body layer 123.

When the structure 1 has the configuration in which the adsorption force of the hard layer 121 is larger than the adsorption force of the body layer 123, the adsorption force of the hard layer 121 may be set to decrease as the distance from the adhesive interface 131 increases. With this configuration, the strength at the adhesive interface 131 can be reliably increased, and hence the above-described functions and advantages can be reliably provided. In addition, an area of parts on which stress concentrates decreases by changing the state of the adhesive resin little by little, and hence there are such other advantages that force is prevented from being applied near the adhesive interface 131. The adsorption force of the hard layer 121 may be gradually reduced as the distance from the adhesive interface 131 increases, or may be reduced in a stepwise manner as the distance from the adhesive interface 131 increases.

Similarly, when the structure 1 has the configuration in which the elastic modulus of the hard layer 121 is higher than the elastic modulus of the body layer 123, the elastic modulus of the hard layer 121 may be set to decrease as the distance from the adhesive interface 131 increases. With this configuration, the strength at the adhesive interface 131 can be reliably increased, and hence the above-described functions and advantages can be reliably provided. In addition, displacement by the stress varies in a stepwise manner, and hence there are such still other advantages that abrupt stress concentration due to differences in displacement can be easily prevented. The elastic modulus of the hard layer 121 may be gradually reduced as the distance from the adhesive interface 131 increases, or may be reduced in the stepwise manner as the distance from the adhesive interface 131 increases.

In the structure 1, a thickness of the hard layer 121 may be set to 0.5 μm or more. With this configuration, the adsorption force and the elastic modulus of the adhesive resin near the adhesive interface 131 are higher, and the density of the adhesive resin are higher. Thus, there are such advantages that the adhesive resin near the adhesive interface 131 is prevented from being weakened by a permeating solvent or a permeating gas. From a viewpoint of, for example, ease of preventing permeation of solvent or permeation of gas through the adhesive resin, the thickness of the hard layer 121 may preferably be set to 1 μm or more, more preferably to 2 μm or more, or much more preferably to 5 μm or more. In addition, in this case, from another viewpoint of, for example, ease of reducing a risk due to curing of an entirety of the adhesive resin that an increase in density of the adhesive resin results in degradation of flexibility of the adhesive resin and in vulnerability, for example, to the thermal shock, the thickness of the hard layer 121 may preferably be set to 2 mm or less. Note that, from the graph showing the above-described relationship between the adsorption force and the distance from the adhesive interface 131 in the cross-section of the adhesive layer 12, and from the graph showing the above-described relationship between the elastic moduli and the distance from the adhesive interface 131 in the cross-section of the adhesive layer 12, the thickness of the hard layer 121 can be calculated as a distance from the adhesive interface 131 to an interface between the hard layer 121 and the body layer 123.

The adhesive layer 12 in the structure 1 according to this embodiment may be used, for example, as a resin coating on the surface of the aluminum base 111, or as a sealing member formed on the surface of the aluminum base 111.

### Second Embodiment

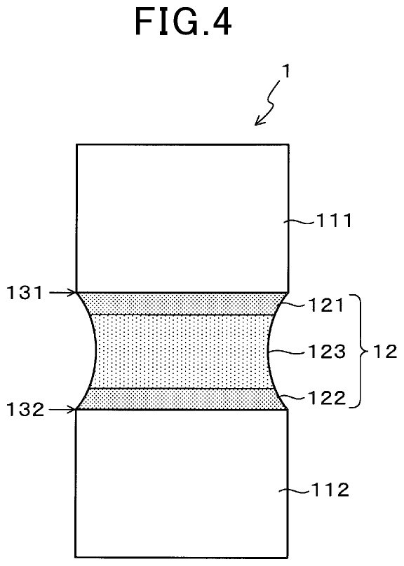

The structure 1 according to a second embodiment is described with reference to FIG. 4. Note that, unless otherwise noted, among reference symbols to be used in the second embodiment and subsequent embodiments, the same ones as those in the foregoing embodiment denote, for example, the same components as those in the forgoing embodiment.

As exemplified in FIG. 4, similar to the structure 1 according to the first embodiment, the structure 1 according to this embodiment includes the aluminum base 111 and the adhesive layer 12. The structure 1 according to this embodiment further includes an aluminum base 112.

Specifically, the structure 1 according to this embodiment includes the aluminum base 111, the aluminum base 112, and the adhesive layer 12 that are arranged between these aluminum bases 111 and 112 and made of the adhesive resin adhering to the surface of the aluminum base 111 and a surface of the aluminum base 112. In other words, the structure 1 according to this embodiment is a joint structure formed by joining the aluminum base 111 and the aluminum base 112 to each other with the adhesive layer 12.

As exemplified in FIG. 4, more specifically, the adhesive layer 12 includes the hard layer 121 that abuts against the adhesive interface 131 between the hard layer 121 and the aluminum base 111, a hard layer 122 that abuts against an adhesive interface 132 between the layer 122 and the aluminum base 112, and the body layer 123 that abuts against the hard layer 121 and the hard layer 122. In addition, the hard layer 121 is harder than the body layer 123, and the hard layer 122 is also harder than the body layer 123. The aluminum base 112, the adhesive interface 132, and the hard layer 122 may be configured similar to the aluminum base 111, the adhesive interface 131, and the hard layer 121 as described in the first embodiment. Note that, an aluminum alloy or the like forming the aluminum base 112 may be the same as or may be different from that of the aluminum base 111.

Note that, in this embodiment, the above-described aluminum base 111 may be referred to also as a first aluminum base, the above-described aluminum base 112 may be referred to also as a second aluminum base, the above-described hard layer 121 may be referred to also as a first hard layer, the above-described hard layer 122 may be referred to also as a second hard layer, the above-described adhesive interface 131 may be referred to also as a first adhesive interface, and the above-described adhesive interface 132 may be referred to also as a second adhesive interface.

The structure 1 according to this embodiment can be provided as a joint structure that is capable of exhibiting high adhesion strength even in the case of being exposed to a solvent for a long time period or to thermal shock.

In the structure 1, the thickness of the first hard layer 121 and a thickness of the second hard layer 122 may each be set to 1 μm or more. With this configuration, the elastic modulus of the first hard layer 121 and an elastic modulus of the second hard layer 122 are increased, and hence strength at the first adhesive interface 131 and strength at the second adhesive interface 132 are increased. Thus, there are such advantages that cleavage at the first and second adhesive interfaces 131 and 132 and therearound is prevented. From a viewpoint of, for example, increasing the strength at the first and second adhesive interfaces 131 and 132, the thickness of each of the first and second hard layers 121 and 122 may preferably be set to 2 μm or more, more preferably to 3 μm or more, or much more preferably to 5 μm or more. In addition, in this case, from another viewpoint of, for example, ease of preventing hinderance to release of internal stress in a case where the elastic moduli excessively increase, the thickness of each of the first and second hard layers 121 and 122 may preferably be set to 2 mm or less.

The structure 1 according to this embodiment may be used in joining an aluminum member and another aluminum member to each other. More specifically, the structure 1 according to this embodiment is applicable to various uses such as joining an aluminum pipe and a piping member (such as a joint member and a fixing member) to each other and joining pipes to each other, or joining a heat exchanger and peripheral components of the heat exchanger to each other, specifically, joining members of the heat exchanger to each other and joining the heat exchanger and pipes to each other. Other configuration features and functions and advantages are the same as those of the first embodiment.

### EXPERIMENTAL EXAMPLES

### Experimental Example 1

### —Preparation of Sample 1 And Sample 1C—

An aluminum base with an oxide-film layer was formed to have a length 1 of 40 mm, a width w of 10 mm, and a thickness t of 1 mm, and then washed with alkali. Next, the aluminum base was immersed for 1 minute in a sodium-silicate aqueous solution at a pH of 12.4, a liquid temperature of 50° C., and a sodium-silicate concentration of 0.4 mol/L. After that, the aluminum base was washed with pure water. In this way, a surface of the aluminum base was modified. This modified layer of the surface of the aluminum base is a thin-film layer that is made of silicate glass containing a solid solution of Al elements that are formed of an oxide-film layer which is made of Al₂O₃.

Next, two aluminum bases were prepared as described above, and then arranged to overlap with each other in a range of 10 mm under a state in which a clearance was secured between surfaces of respective end portions of the bases. Note that, the clearance was set to 200 μm. Then, an adhesive-resin material was applied to the end portions with the clearance formed therebetween. As the adhesive-resin material, an epoxy-resin material containing 2,2-bis(4-hydroxyphenyl)propan diglycidyl ether (BPADGE) as a main agent and dicyandiamide (DYCI) as a curing agent was used. Then, the adhesive-resin material was heated to 80° C. With this, the adhesive-resin material was reduced in viscosity and fluidized to move to fill the clearance. In this way, a laminate having a laminated structure in which the aluminum base, the adhesive-resin material, and the aluminum base were laminated in this order was obtained.

Next, the obtained laminate was heated and maintained at 135° C. for 10 minutes, and then heated further and maintained at a higher temperature of 155° C. for 20 minutes. With this, the adhesive-resin material was cured, and then naturally cooled. In this way, a structure of a sample 1 was obtained, the structure including the aluminum base and an adhesive layer that is made of the epoxy resin adhering to the surface of the aluminum base (specifically, a structure having the laminated structure in which the aluminum base, the adhesive layer, and the aluminum base were laminated in this order). Note that, in the structure of the sample 1, the adhesive resin in the hard layer is covalently bonded to the modified surface of the aluminum base.

Next, a structure of a sample 1C, the structure including the aluminum base and the adhesive layer that is made of the epoxy resin adhering to the surface of the aluminum base (specifically, the structure having the laminated structure in which the aluminum base, the adhesive layer, and the aluminum base were laminated in this order), was obtained in the same way as that in the preparation of the structure of the sample 1 except that the aluminum bases were not immersed in the sodium-silicate aqueous solution.

### —Preparation of Sample 2 And Sample 2C—

A structure of a sample 2, the structure including the aluminum base and an adhesive layer that is made of a silicone resin adhering to the surface of the aluminum base, was obtained in the same way as that in the preparation of the structure of the sample 1 except that an epoxy-modified silicone resin material (“DOWSIL SE1714” manufactured by Dow Toray Co., Ltd.) was used as the adhesive-resin material, except that a laminate was formed by applying the silicone resin material to the surfaces of the respective end portions of the two aluminum bases under the state in which the two aluminum bases overlap with each other in the range of 10 mm, and by applying the two aluminum bases to each other under the state in which the clearance of 200 μm was secured between the surfaces of the respective end portions of the bases, and except that the obtained laminate was heated and maintained at 140° C. for 5 minutes, then heated further and maintained at a higher temperature of 170° C. for 5 minutes, and then naturally cooled. Note that, in the structure of the sample 2, the adhesive resin in the hard layer is covalently bonded to the modified surface of the aluminum base.

Next, a structure of a sample 2C, the structure including the aluminum base and the adhesive layer that is made of the silicone resin adhering to the surface of the aluminum base, was obtained in the same way as that in the preparation of the structure of the sample 2 except that the aluminum bases were not immersed in the sodium-silicate aqueous solution.

### —Measurement of Adsorption-Force Image by Using Scanning Probe Microscope—

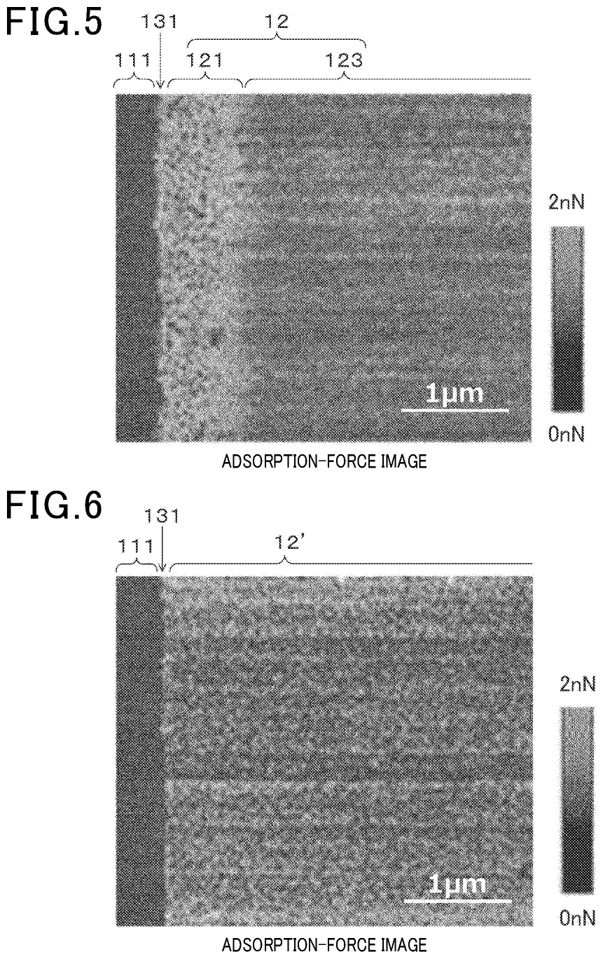

Measurement samples each having the cross-section of the adhesive layer, the cross-section being perpendicular to the adhesive interface, were collected from the structures of the sample 1 and the sample 1C. Note that, the cross-section of each of the measurement samples was prepared with FIB after the structures were cut with a wire saw. The same applies hereinafter. Then, surface observation of the cross-section of each of the adhesive layers was performed by using the scanning probe microscope, and an adsorption-force image of each of the adhesive layers was measured. Note that, the adsorption-force image was generated by obtaining and mapping the adsorption force at respective points, the adsorption force being calculated by performing the measurement under the above-described measurement conditions with respect to the entirety of each of the cross-sections. The adsorption-force image of the cross-section of the adhesive layer of the sample 1 is depicted in FIG. 5. The adsorption-force image of the cross-section of the adhesive layer of the sample 1C is depicted in FIG. 6.

As depicted in FIG. 6, the adsorption force was substantially uniform all over the adhesive layer of the structure of the sample 1C. This demonstrates that, in the structure of the sample 1C, a crosslink density of the epoxy resin forming the adhesive layer does not vary in a thickness direction, that is, an entirety of the adhesive layer has uniform hardness. In other words, the adhesive layer of the structure of the sample 1C does not have the configuration including the hard layer and the body layer. In contrast, as depicted in FIG. 5, the adsorption force was larger in a certain region on a side where the adhesive layer of the structure of the sample 1 was present relative to the adhesive interface between the aluminum base and the adhesive layer than on an inner side of the adhesive layer relative to the certain region. This demonstrates that, in the structure of the sample 1, the crosslink density of the epoxy resin forming the adhesive layer varies in the thickness direction, specifically, the crosslink density is higher in the certain region on the side where the adhesive layer is present relative to the adhesive interface than on the inner side of the adhesive layer relative to the certain region. In other words, the adhesive layer of the structure of the sample 1 includes the body layer on the inner side, and the hard layer that is harder than the body layer. Note that, the same results as those obtained from the structures of the sample 1 and the sample 1C were obtained also from the structures of the sample 2 and the sample 2C.

### —Measurement of Elastic-Modulus Image by Using Scanning Probe Microscope—

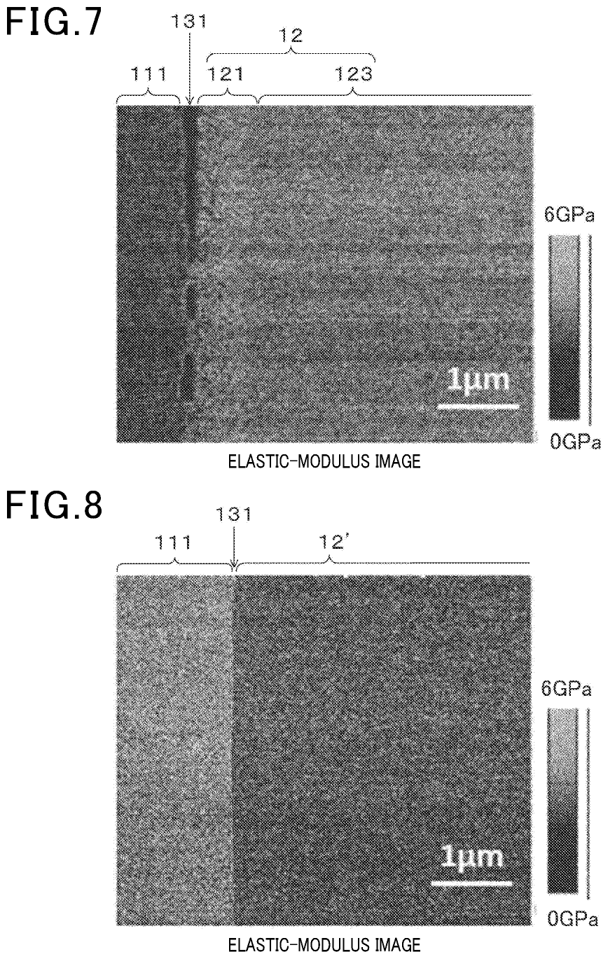

Measurement samples each having the cross-section of the adhesive layer, the cross-section being perpendicular to the adhesive interface, were collected from the structures of the sample 1 and the sample 1C. Then, the surface observation of the cross-section of each of the adhesive layers was performed by using the scanning probe microscope, and an elastic-modulus image of each of the adhesive layers was measured. Note that, the elastic-modulus image was generated by obtaining and mapping elastic moduli at the respective points, the elastic moduli being calculated by performing the measurement under the above-described measurement conditions with respect to the entirety of each of the cross-sections. The elastic-modulus image of the cross-section of the adhesive layer of the sample 1 is depicted in FIG. 7. The elastic-modulus image of the cross-section of the adhesive layer of the sample 1C is depicted in FIG. 8.

As depicted in FIG. 8, the elastic modulus was substantially uniform all over the adhesive layer of the structure of the sample 1C. This demonstrates that, in the structure of the sample 1C, the crosslink density of the epoxy resin forming the adhesive layer does not vary in the thickness direction, that is, the entirety of the adhesive layer has uniform hardness. In other words, the adhesive layer of the structure of the sample 1C does not have the configuration including the hard layer and the body layer. In contrast, as depicted in FIG. 7, the elastic modulus was higher in the certain region on the side where the adhesive layer of the structure of the sample 1 was present relative to the adhesive interface between the aluminum base and the adhesive layer than on the inner side of the adhesive layer relative to the certain region. This demonstrates that, in the structure of the sample 1, the crosslink density of the epoxy resin forming the adhesive layer varies in the thickness direction, specifically, the crosslink density is higher in the certain region on the side where the adhesive layer is present relative to the adhesive interface than on the inner side of the adhesive layer relative to the certain region. In other words, the adhesive layer of the structure of the sample 1 includes the body layer on the inner side, and the hard layer that is harder than the body layer. Note that, the same results as those obtained from the structures of the sample 1 and the sample 1C were obtained also from the structures of the sample 2 and the sample 2C.

### Experimental Example 2

—Relationships Between Distances from Adhesive Interface in Cross-Sections of Adhesive Layers And Adsorption Force Or Elastic Moduli—

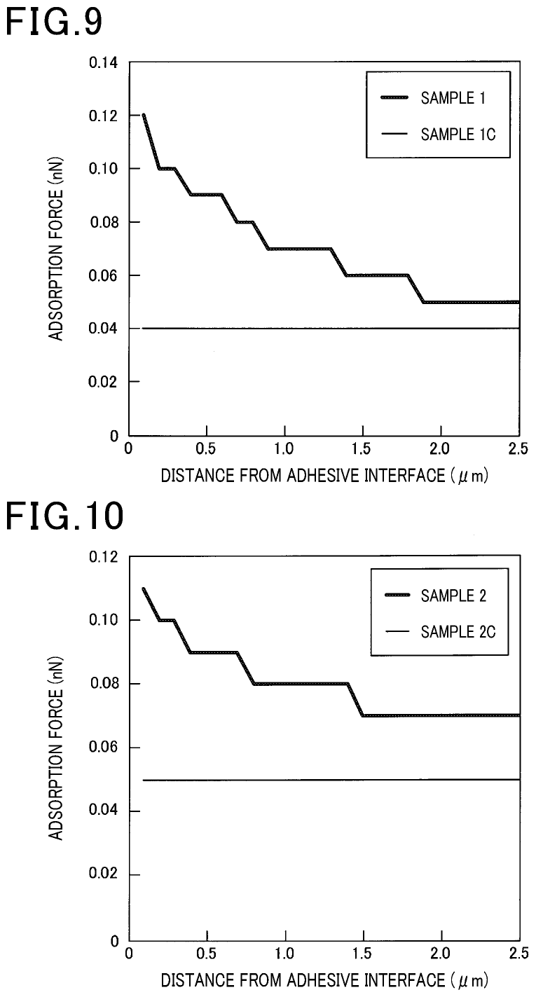

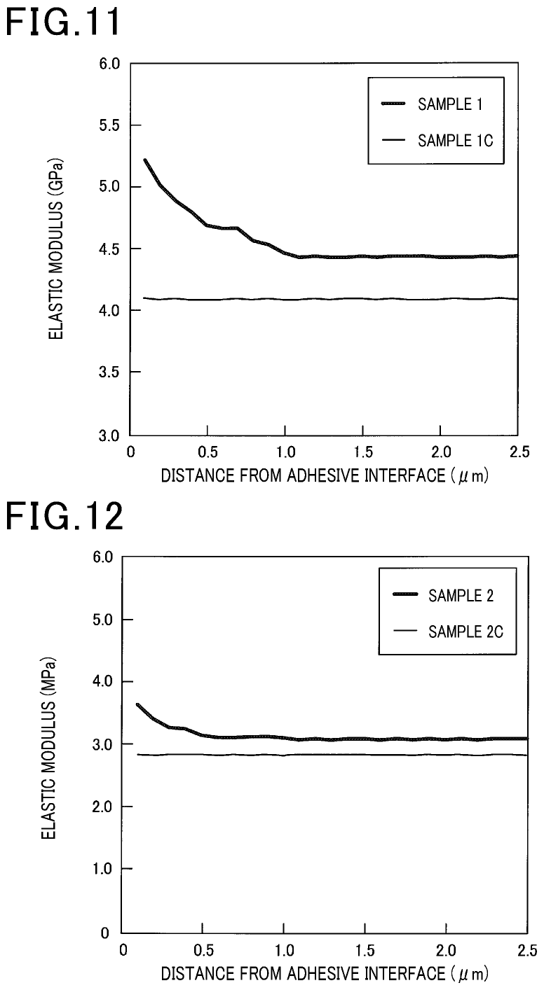

Measurement samples each having the cross-section of the adhesive layer, the cross-section being perpendicular to the adhesive interface, were collected from the structures of the sample 1 and the sample 1C. Then, under the above-described measurement conditions, by performing, using the scanning probe microscope, the surface observation of the cross-section of each of the adhesive layers, a relationship between the adsorption force and the distance from the adhesive interface in the cross-section of each of the adhesive layers, and a relationship between the elastic modulus and the distance from the adhesive interface in the cross-section of each of the adhesive layers were measured. Relationships between the adsorption force and the distances from the adhesive interfaces in the cross-sections of the adhesive layers of the sample 1 and the sample 1C are shown in FIG. 9. Relationships between the adsorption force and distances from adhesive interfaces in the cross-sections of the adhesive layers of the sample 2 and the sample 2C are shown in FIG. 10. Relationships between the elastic moduli and the distances from the adhesive interfaces in the cross-sections of the adhesive layers of the sample 1 and the sample 1C are shown in FIG. 11. Relationships between the elastic moduli and the distances from the adhesive interfaces in the cross-sections of the adhesive layers of the sample 2 and the sample 2C are shown in FIG. 12.

FIG. 9, FIG. 10, FIG. 11, and FIG. 12 demonstrate that the adsorption force and the elastic moduli of the structures of the sample 1C and the sample 2C are uniform irrespective of the distances from the adhesive interfaces. This demonstrates that, in each of the structures of the sample 1C and the sample 2C, the crosslink density of the adhesive resin forming the adhesive layer does not vary in the thickness direction, that is, the entirety of the adhesive layer has uniform hardness. In contrast, as shown in FIG. 9, FIG. 10, FIG. 11, and FIG. 12, the adsorption force and the elastic modulus were higher within a certain distance on the side where the adhesive layers of the structures of the sample 1 and the sample 2 were present relative to the adhesive interfaces between the aluminum bases and the adhesive layers than beyond the certain distance. This demonstrates that, in each of the structures of the sample 1 and the sample 2, the crosslink density of the adhesive resin forming the adhesive layer varies in the thickness direction, specifically, the crosslink density is higher within the certain distance on the side where the adhesive layer is present relative to the adhesive interface than on the inner side of the adhesive layer beyond the certain distance. In other words, the adhesive layer of each of the structures of the sample 1 and the sample 2 includes the body layer on the inner side, and the hard layer that is harder than the body layer. Note that, both the hard layers in the structures of the sample 1 and the sample 2 decreased in size as distances from the adhesive interfaces increased.

### Experimental Example 3

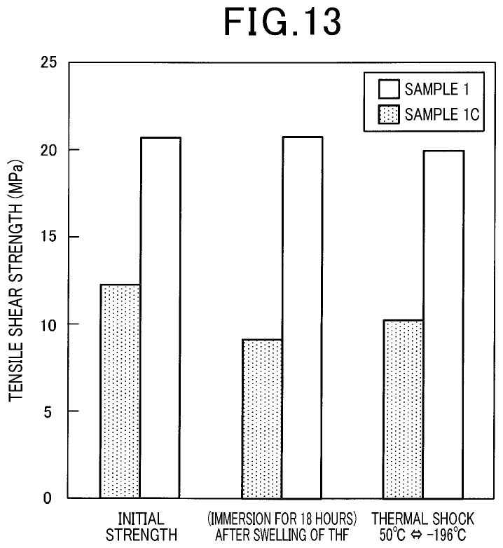

Tensile shear strength of structures of the sample 1 and the sample 1C in an initial state, structures of the sample 1 and the sample 1C that were immersed in tetrahydrofuran (THF) for 18 hours, and structures of the sample 1 and the sample 1C that were subjected to ten repeated thermal cycles in each of which heating to 50° C. and cooling to −196° C. were performed was measured. The measurement was performed by using a universal testing apparatus (“AUTOGRAPH” manufactured by Shimadzu Corporation.) under measurement conditions of a tensile speed of 5 mm/min, a grip width of 10 mm, and the number of times of measurement of 6. Results of the measurement are shown in FIG. 13.

As shown in FIG. 13, initial tensile-shear strength of the structure of the sample 1 was higher than that of the structure of the sample 1C. This is because the adhesive layer of the structure of the sample 1C did not include the hard layer, and because the adhesive resin adhered to the surface of the aluminum base, for example, by the anchoring effect or by the hydrogen bonding. In contrast, in the structure of the sample 1, the strength near the adhesive interface was increased by the hard layer, and there was a synergistic advantage that the adhesive resin in the hard layer was covalently bonded to the surface of the aluminum base. This is probably why the initial tensile-shear strength increased.

In addition, as shown in FIG. 13, degradation in tensile shear strength of the structure of the sample 1 was smaller than that of the structure of the sample 1C both after the immersion in THF and after the thermal-cycle loading. Thus, the structure of the sample 1 successfully maintained high tensile-shear strength. Note that, although a main fracture pattern of the sample 1 was the base-material fracture in the body layer, a main fracture pattern of the structure of the sample 1C was the interfacial peeling. In addition, the same results as those obtained from the structures of the sample 1 and the sample 1C were obtained also from the structures of the sample 2 and the sample 2C.

The present disclosure is not limited to the above-described embodiments or Experimental Examples, and may be variously modified within the gist of the present disclosure. In addition, the configurations described in the embodiments and Experimental Examples may be arbitrarily combined with each other.

The following are the reference examples.

(1) A structure comprising:

an aluminum base; and

an adhesive layer configured to:
be made of an adhesive resin adhering to a surface of the aluminum base, and
include:
   a hard layer that abuts against an adhesive interface where the hard layer is adhered to the aluminum base, and
   a body layer that abuts against the hard layer,
   the hard layer being harder than the body layer.

As examples of the adhesive resin, there may be given an epoxy resin, a polyurethane resin, a melanin resin, a urea resin, a silicone resin, and a polyester resin. Of these, the epoxy resin and the silicone resin are preferred as the adhesive resin.

(2) The structure according to (1), wherein adsorption force of the hard layer is larger than adsorption force of the body layer, the adsorption force being measured by using a scanning probe microscope in a cross-section of the adhesive layer perpendicular to the adhesive interface.

(3) The structure according to (2), wherein the adsorption force of the hard layer decreases as a distance from the adhesive interface increases.

(4) The structure according to anyone of (1)-(3), wherein an elastic modulus of the hard layer is higher than an elastic modulus of the body layer, the elastic moduli being measured by using a scanning probe microscope in a cross-section of the adhesive layer perpendicular to the adhesive interface.

(5) The structure according to (4), wherein the elastic modulus of the hard layer decreases as a distance from the adhesive interface increases.

(6) The structure according to anyone of (1)-(5), wherein the adhesive resin is an epoxy resin or a silicone resin.

(7) The structure according to anyone of (1)-(6), wherein a thickness of the hard layer is 0.5 μm or more.

(8) The structure according to anyone of (1)-(6), wherein a thickness of the hard layer is 1 μm or more.

What is claimed is:

1. A structure comprising:
an aluminum base; and
an adhesive layer configured to:
be made of an adhesive resin adhering to a surface of the aluminum base, the adhesive resin being an epoxy resin or a silicone resin, and
include:
a hard layer that abuts against an adhesive interface where the hard layer is adhered to the aluminum base, and
a body layer that abuts against the hard layer,
the hard layer being harder than the body layer.

2. The structure according to claim 1, wherein adsorption force of the hard layer is larger than adsorption force of the body layer, the adsorption force being measured by using a scanning probe microscope in a cross-section of the adhesive layer perpendicular to the adhesive interface.

3. The structure according to claim 2, wherein the adsorption force of the hard layer decreases as a distance from the adhesive interface increases.

4. The structure according to claim 1, wherein an elastic modulus of the hard layer is higher than an elastic modulus of the body layer, the elastic moduli being measured by using a scanning probe microscope in a cross-section of the adhesive layer perpendicular to the adhesive interface.

5. The structure according to claim 4, wherein the elastic modulus of the hard layer decreases as a distance from the adhesive interface increases.

6. The structure according to claim 1, wherein a thickness of the hard layer is 0.5 μm or more.

7. The structure according to claim 1, wherein a thickness of the hard layer is 1 μm or more.
